(19) United States
(12) Patent Application Publication
(10) Pub. No.: US 2009/0211665 A1
(43) Pub. Date: Aug. 27, 2009

(54) Sawing apparatus and method for using a sawing apparatus

(76) Inventor: Arvo Nuutinen, Kokkola (FI)

Correspondence Address: Fay Sharpe LLP, 1228 Euclid Avenue, 5th Floor, The Halle Building, Cleveland, OH, 44115, US

(21) Appl. No.: 11/887,098

(22) PCT Filed: Mar. 17, 2006
(86) PCT No.: PCT/FI2006/000093

§ 371 Date: Jan. 15, 2009

(30) Foreign Application Priority Data
Mar. 22, 2005 (FI) 20050305

(51) Int. Cl. B27B 1/00; B27M 1/08

(52) U.S. Cl. 144/357; 144/367

(57) ABSTRACT

A sawing apparatus (1) for cutting elongated timber (3) to form cut-to-size pieces, the apparatus including a horizontal processing line (2), through which the timber being processed is guided; transfer means for transferring the timber longitudinally along the processing line as well as machining means for machining the timber in the processing line. The machining means include at least one circular saw (9) whose sawing angle is adjustable and whose blade can be moved across the processing line for cutting the timber. According to the invention, the transfer means include an elongated magnetic rail (6) parallel to the processing line (2); at least two linear motor slides (7) arranged to be movable independently with respect to one another along the magnetic rail; and for each linear motor slide, a transfer gripper (4) connected to the slide and arranged to grasp the timber being processed for moving it longitudinally along the processing line.

### FIELD OF THE INVENTION

The invention relates to a sawing apparatus as defined in the preamble of claim 1 for cutting elongated timber to cut-to-size pieces as well as to a method as defined in the preamble of claim 12 for using a sawing apparatus.

### BACKGROUND OF THE INVENTION

The parts of various wooden structures, such as those of roof trusses or, for example, those of timber walls need to be machined to form cut-to-size pieces prior to the manufacture of the structure. Besides cutting to size, for example, the ends of parts of roof trusses or similar shall typically also be provided with bevels of different directions to join the parts against one another at different angles. The directions of the bevels or bevel combinations, as well as also the lengths of the usually elongated components have to be implemented so as to have high dimensional accuracy to make the joints of the components sufficiently durable. In addition to the accuracy, the production shall be sufficiently efficient.

Bevels of different directions are usually implemented by sawing. Efficient production requires that the sawing of the parts is effected with sufficient speed and accuracy. Therefore, a number of various at least partly automatic sawing apparatuses—or apparatuses to cut the timber in the desired directions and to the desired length have been developed. One general characteristic in these is that the conveyance of the timber is effected by means of gripper elements or roller conveyors or grippers connected to belts, chains or similar used by rotating electric motors. Due their complicated and costly mechanical structure, these are very susceptible to wear or problems caused by wood dust, which increases the need for maintenance and costs associated with maintenance. Furthermore, particularly the conveyance of timber which is carried out using various roller conveyors is very inaccurate, resulting in multiplied sawing inaccuracies when the same piece is sawed a number of times and moved in the meanwhile. Another alternative is to make a re-measurement prior to every work phase, which can also result in big measurement inaccuracies in the final product.

For example, patent publication U.S. Pat. No. 6,615,100 B1 discloses an automatic computer controlled sawing apparatus for cutting the parts for roof trusses. The apparatus comprises a servo motor-controlled saw which is adjustable with respect to its sawing angle and movable in a vertical direction, as well as roller conveyors and also servo motor-driven roller pushers for conveying timber to and from a sawing station. A conveyor that is based on rollers rolling under the timber includes quite a large number of parts that wear and requires a lot of maintenance to maintain the operation thereof. In addition, the disclosed apparatus requires feeding of the timber to and from the conveyor to be performed separately manually or to be arranged in some other manner, because it is just before or immediately after the sawing station that the roller pushers grasp the timber. The publication also discloses how the apparatus requires a constantly present operator to operate, and the operator, for example, starts up the apparatus and takes care of the feeding of the timber to and from the conveyor. As the horizontal possibility of movement is lacking, the presented solution cannot be used to implement very long sawing lines. On the basis of the facts described above, the presented apparatus does not meet the requirements of large-scale industrial production, but is better suitable for small-scale operations.

The processing of timber can also be enhanced by using more than one saw. Patent publication WO 97/01421 discloses an apparatus and method that are based on simultaneous use of two turning saws, permitting simultaneous sawing of the timber at both ends at the desired angles. Prior to making the saw cuts, the saw units are moved to the required distance from one another and to the desired angles. Moving an entire saw unit to a distance each time required by the length of the part being sawed is a cumbersome and time-consuming procedure, and the mechanism required by it also increases the need for maintenance. Furthermore, also in this solution, the conveyance of timber is based on a roller conveyor including a number of parts that wear. The feeding of the timber to the conveyor is performed manually. As a whole, this apparatus is not designed either to be integrated into an efficient fully automated production system.

To cut profile strips to form cut-to-size strip pieces, publication EP 699496 A1 discloses an apparatus which also uses two saws simultaneously to cut the strip to form a strip piece of a desired length. The length of the strip piece is also herein determined by adjusting the distance between the saws. A long strip is picked up from a supply by an overhead grip which is moving on an overhead guide rail and transfers the strip into position for sawing thereby holding the strip in place while the saws move across the strip and cut it. A strip piece that has been cut to size is put aside to be conveyed away from the sawing apparatus. This apparatus, too, necessitates moving one of the saws each time there is a wish to change the length of the strip pieces being cut. Therefore, as a main rule, the apparatus is suited for a production where large numbers of strip pieces of a given length are cut and where the length is seldom changed. In the presented solution, the saws dot no permit making bevels at the ends of the strips. Furthermore, the apparatus is specifically designed for cutting rather lightweight strips. Consequently, the solution is not very useful in manufacturing, for example, parts of a roof truss that are typically rather heavy, of unequal length and include different bevels.

### OBJECTIVE OF THE INVENTION

It is an objective of the invention to eliminate the drawbacks referred to above.

One specific objective of the invention is to disclose a new type of sawing apparatus and method for cutting timber to form cut-to-size pieces with high accuracy, the apparatus and method being very efficient, automatically operable, and requiring just a little maintaining work compared to the prior-art solutions.

### SUMMARY OF THE INVENTION

The sawing apparatus of the invention is characterised by what has been presented in claim 1. The method of the invention for using a sawing apparatus is characterised by what has been presented in claim 14.

The sawing apparatus for cutting elongated timber to form cut-to-size pieces includes a horizontal processing line through which the timber being processed is guided. The apparatus also includes transfer means for transferring the timber longitudinally along the processing line, as well as machining means for machining the timber. The machining means include at least one circular saw whose sawing angle is adjustable and whose blade can be moved along the processing line for cutting the timber. A processing line is simply used to mean a space reserved for processing the timber that can be provided with, for example, various support planes for supporting the timber. A circular saw is used to mean a saw with a discoidal blade that rotates about its middle axis in its own plane. Adjusting the sawing angle means herein turning the saw blade about the vertical axis so as to be parallel to the desired sawing line. The sawing angle can preferably be adjusted from the transverse direction of 90° of the processing line into both directions, enabling one to implement all the necessary sawing angles. The adjusting devices and drives necessary in adjusting the blades can be based on, for example, conventional AC servo motors.

According to the invention, the transfer means include an elongated magnetic rail parallel to the processing line, as well as at least two slides of a linear motor, arranged to be movable independently with respect to one another along the aforementioned magnetic rail. Each linear motor slide forms an electric linear motor together with the magnetic rail. For guiding and limiting the movement of the slide which moves on the rail at a distance of an air slot from the magnetic rail, the apparatus can naturally also include various linear guides. Each slide includes, in addition, a transfer gripper connected to the slide and arranged to grasp the timber for transferring it longitudinally along the processing line. Several transfer grippers connected independent of each other to the slides being guided and movable using direct linear drive enable the use of a sawing apparatus that is very efficient and can be flexibly adapted to various production situations. One can, for example, transfer a piece being machined into position for machining using a first transfer gripper and after the machining phase use a second gripper for the further transfer, whereby the first gripper is released to pick up the following piece. For purposes of grasping the timber, the transfer grippers can include, for example, two opposite gripper parts that move crosswise with respect to the processing line for grasping the timber by tightening it between the gripping surfaces. The magnetic rail and the movement range of the slides on the rail preferably extend over the entire length of the apparatus and more preferably even beyond it, whereby no separate conveyors are needed for feeding the timber to and from the apparatus. The use of a linear motor which is to be guided automatically, e.g. using servo control, enables very high acceleration and speed of the timber being transferred, as well as excellent positioning accuracy. A linear motor also avoids the flexibility and lost motions associated with mechanical transmission. Furthermore, the linear motor slides that move in a substantially frictionless manner on the magnetic rail considerably reduce the need for maintenance caused by the wear of the parts. Of the structures of the processing line, the separate transfer grippers enable a very simple structure of the processing line.

In one preferred embodiment of the invention, there are two circular saws of the aforementioned type, the saws being disposed consecutively in the direction of the processing line. Two saws enable one to enhance the processing of the timber because both saws can be used simultaneously. Preferably, the saws are arranged to be guided independently independent of each other, whereby the necessary saw cuts can be made using each saw in a most efficient manner and at the most suitable moments of time without the need for taking into account the operation of the other saw.

In one preferred embodiment of the invention, there are three combinations of a linear motor and a transfer gripper connected to it. For example, in the case of two saws, this enables a very preferred use of the apparatus using the method of the invention which will be described hereinafter.

The blade of the circular saw is preferably upright, although it is possible to arrange the blade to be turned into a direction deviating from the vertical one. A vertical direction is herein used to mean a direction which is substantially parallel to the normal of the substantially horizontal floor surface which serves as the supporting surface of the apparatus. Correspondingly, a horizontal direction is used to mean a direction that is substantially in the plane of the aforementioned floor surface.

The blade of the circular saw of the sawing apparatus of the invention is preferably arranged to be movable in the horizontal direction defined by the plane of the blade. In other words, the blade can be moved in the direction of the sawing line, enabling e.g. the implementation of sawing lines longer than the blade diameter.

In addition, in one embodiment of the invention, the circular saw is arranged to be movable in a crosswise direction with respect to the processing line. This fact together with the possibility of moving the blade in parallel to the sawing line as described above makes it possible to saw very long bevels in also relatively wide timber and thus further considerably improves the performance of the apparatus. It is possible to make bevels with the dimensions of several meters in parts so that between the partial saw cuts, both the entire saw and the saw blade are moved in a crosswise direction with respect to the processing line in the sawing line into a place required by the next partial saw cut. Both the motion of the saw blade which was described above and the possibility of moving the entire saw can naturally also be utilised in moving the blade, prior to the sawing, into a place where the actual sawing step can be performed with the least possible movements during the sawing.

The blade of the circular saw is preferably arranged to be also movable in a vertical direction. This fact together with the possibility of moving the saw blade and/or the entire saw, which was described above, makes it possible e.g. that prior to the sawing, above or underneath the actual processing line, the saw blade can be quickly moved into the most optimal position to minimise the sawing movements, after which it can be lifted or lowered into contact with the timber for cutting it.

To implement the movements of the circular saw blade and those of the entire saw which were described above, the apparatus can include various power units, e.g. conventional servo controlled electric motors.

A transfer gripper to be movable in the longitudinal direction of the apparatus using a linear motor is preferably arranged to be also movable in the vertical direction through a stretch larger than the thickness of the timber being processed. This fact permits transverse horizontal movement of the transfer gripper and the timber relative to each other with respect to the elongated processing line in situations where the transfer gripper is not used to hold the timber in place. Vertical movement can be implemented using e.g. a pneumatically operated actuator.

The transfer gripper is preferably further arranged to be movable in a transverse horizontal direction with respect to the processing line. First, this fact enables horizontal positioning of the timber being processed into a desired place. Second, this kind of transfer gripper that can also be moved in the vertical direction in a manner as described above can be put aside from the processing line between the tasks of transferring and be moved into a place required by the next step of transferring. In this manner, the processing line is left free for the machining devices to move. A transfer gripper which can be put aside also enables the fact that a completed piece of wood can be moved aside from the processing line, e.g. to a separate conveyor, while it is being transferred forward from the last machining means. This makes space for the next piece enabling one to make the saw shorter when the processing line can be made shorter at its exit end. Horizontal movement of the transfer gripper can be implemented using e.g. pneumatically operated actuators.

Preferably, the machining devices of the sawing apparatus comprise, in addition, a milling cutter for making indentations in the timber. An indentation as such may be necessary at the end or side of timber such as a log, or it can act as an auxiliary indentation of a long sawing line which is substantially parallel to the timber, whereby the sawing line of the circular saw starts from and/or ends in a suitable indentation made using a milling cutter.

Further, the machining means can include a drill for making holes in the timber. For example, in this manner, as early as in the manufacturing phase of the parts of a truss, certain parts of roof trusses can be provided with the holes needed in them in the erection phase of a building.

The sawing apparatus of the invention has preferably been provided with a positioning gripper disposed in conjunction with the machining means for positioning the timber in a crosswise direction with respect to the processing line prior to the machining phase. When even a crosswise positioning is determined in this manner by means of grippers, the structures necessary in the processing line can consist of e.g. a sheer plane surface or just of supports disposed at a suitable distance from one another substantially in the same horizontal plane. The positioning gripper can include two gripper elements that are moving symmetrically relative to the centre line of the processing line and in a crosswise direction with respect to the processing line, the gripper elements grasping the timber by its vertical side walls. With centralizing grippers such as these the centre line of the timber can always be positioned to match up with the centre line of the processing line irrespective of the width of the timber. Alternatively, the positioning gripper can include a supporting surface defining one side of the processing line and an opposing piece that presses the timber against this surface. The movement of the gripper elements and the opposing piece can be implemented e.g. pneumatically. The corresponding centralising gripper elements or the supporting surface and the opposing piece can also be implemented e.g. in the transfer grippers. In that case, whilst being fed into the machining means, the timber is substantially positioned even in the crosswise direction, and the positioning grippers are only used to perform the final adjustment. It is also possible that the crosswise positioning is performed using the transfer grippers only, with no need for separate positioning grippers. The positioning gripper can be arranged to be movable in a vertical direction and/or in a crosswise horizontal direction with respect to the processing line. This kind of gripper can be moved aside from the processing line when it is not needed.

Preferably, in conjunction with the machining means there is a holding element for holding the timber in place during the machining step. Holding in place ensures the accuracy of the machining. In the same time the transfer means are released during the machining phases and can move into position for the next transfer, enhancing the operation of the entire sawing apparatus when extra waiting periods are omitted. With no performance losses, in this manner, by means of separate holding and transfer elements it is possible to implement transfer of timber in a processing line and the machining steps so that the timber is being continuously held and its position arranged in a controlled manner. Extra movements of the timber are thus avoided and high accuracy of the shapes being machined is thus made sure of. For example, in conjunction with the saw, the holding element can include press elements which are used to press the timber in the vertical direction tightly against the supporting surface of the processing line near the sawing line, preferably on both sides thereof.

In addition, to remove waste pieces from the processing line, the apparatus preferably includes removal means for putting the waste pieces aside e.g. by blowing. The sawing apparatus may also be provided with marking means for marking and individualising each machined piece for further using the piece.

The entire sawing apparatus which was described above is preferably arranged to be an automatic computer controlled system. This kind of apparatus which functions completely without manual work phases can be integrated so as to be a part of the rest of a production line of a production plant that uses the sawing apparatus and can be controlled by means of the production control system of the production plant.

In the method of the invention for using the sawing apparatus described above, when sawing elongated timber to size, one transfer gripper is used to transfer the piece being machined into position for machining and after the machining step, a second transfer gripper is used to move it forward in the processing line. In this manner, during further transfer, the transfer gripper having transferred the timber into position for machining can be used to transfer the following piece of timber into position for machining. By optimising the efficiency of transfers of timber in this manner, the waiting periods of the machining devices caused by the transfers between the machining processes are minimised. Herein and hereinafter, machining is used to mean sawing or machining using some other machining means included in the sawing apparatus.

In one preferred embodiment of the method of the invention, a first saw is used to saw the first end of an elongated piece of wood, and a second saw is used to saw the second end of the aforementioned piece of wood. Contrary to the prior-art solutions where the length of the piece is determined by the distance between the saws, this procedure allows placing the saws near each other, thanks to which the length of the apparatus can be relatively short. This, for its part, enhances the operation of the apparatus in the form of reduced transfer distances and times. In addition, the saws can be operated in a most efficient manner also because of the fact that both saws can be used simultaneously to machine consecutive pieces without the saws having to wait in vain. Depending on the lengths of the timber and the pieces being made out of it, it is possible to make one or more cut-to-size pieces out of one timber slab. It must be noted that when sawing timber using the sawing apparatus of the invention, the necessary saw cut at the end of a piece of wood can at its simplest be one saw cut which is either perpendicular or oblique with respect to the longitudinal direction of the timber. On the other hand, it is possible to provide one or both ends of the piece of wood being cut to size with two or more sawing lines that can be at different angles with respect to the longitudinal direction of the piece of wood.

More specifically, the method of the invention can include steps that will be described next. The first saw is used to saw the necessary bevels at the first end of an elongated piece of wood, after which the piece is transferred forward in the processing line into a place where the second saw can be used to make the necessary saw cuts at the second end of the piece. At the same time with the aforementioned transfer the following piece of wood is transferred on the processing line into a place which was left free after the first-mentioned piece of wood, where its first end can be sawed using the first saw. Next, the second end of the first piece of wood and the first end of the second piece of wood are sawed substantially simultaneously, though independent of each other, after which each piece of wood is transferred forward on the processing line at the same time as another piece of wood is transferred to the first saw for the purposes of sawing the first end.

In a preferred embodiment of the method of the invention, the piece being machined is transferred using a transfer gripper into the vicinity of a machining means such as a saw and positioned into the right place in a crosswise direction with respect to the processing line. Preferably, while being transferred, the timber is already substantially in the right place in the crosswise direction, whereby in the vicinity of the machining means, just the fine adjustment of the positioning is made. The fine adjustment can be made using separate positioning grippers or the transfer grippers themselves. Thereafter, the timber is grasped with a holding element for holding it in place during the machining phase. In that case, the positioning gripper can be put aside away from the processing line. When the transfer gripper is no longer needed, it is released and moved so as to be ready for the next transfer. This procedure enhances the operation of the apparatus because when the saw cuts have been made, the transfer means is immediately ready to transfer the pieces being machined forward on the processing line. The described method has the very important advantage that while being transferred through the processing line, the timber is being held continuously, thereby preventing extra movements of the timber and ensuring the accuracy of the machining phases.

In one preferred embodiment of the method of the invention, prior to the sawing, the vertical saw blade is turned to be parallel to the desired sawing line and is moved, above or underneath the processing line, into a place where the middle point of the blade substantially matches up with the midpoint of the sawing line in the vertical direction. Thereafter, the actual saw cuts are made with one vertical motion of the saw blade. As the middle point of the blade is moved into the desired place, it is first possible to move the entire saw in a crosswise direction with respect to the processing line. In addition, the blade can be moved in the plane defined by the blade. In this manner, the saw movements required by the actual sawing are minimised. This also makes the processing of timber faster. Alternatively, if the sawing line is so long that a mere vertical movement will not suffice, then prior to the sawing, the middle point of the blade is moved into a place starting from which the saw cuts can be made with the lowest number of saw movements during the sawing.

Depending on the thickness of the timber being processed, besides the facts described above, the efficiency of the production of cut-to-size pieces can be enhanced by processing more than one piece of timber at a time one upon the other.

In the method of the invention, the entire sawing apparatus is guided preferably automatically by means of the production control system of a production plant as a part of the rest of the production line. Automatic, individual control of each saw and transfer gripper by means of a computer enables that if necessary, even every piece being machined can be dissimilar to the previous one.

Compared to the prior-art devices, using the method of the invention a number of substantial advantages are gained in the manufacture of various wooden structures. With the transfer of timber being processed that is based on linear motors, the apparatus can be made operate in a very efficient manner and with high precision. At the same time the need for maintenance is substantially reduced compared to the systems using conventional mechanical transmission, and the processing line can be implemented in a simple manner. Timber, once introduced into the apparatus and determined with respect to its position, stays in an accurately determined position during the entire processing, i.e. the timber is not allowed to freely move during the process. In this manner, during the machining phases to be performed on the timber, no measurement inaccuracies are formed in the timber because of new measurements. Circular saws that can be moved in a versatile manner enable sawing also rather long bevels in the timber.

Two saws and a method for their simultaneous use as well as separate transfer means and holding means also enhance making the timber to form cut-to-size pieces. The efficiency is also enhanced by a sawing method which minimises the time-consuming saw movements during the actual sawing phase. Besides saws, it is possible to connect to the apparatus also other necessary machining means such as a milling cutter and a drill. The apparatus can be integrated to form a fully automatic part of the rest of the production line that can be controlled using the production control system of the plant. The invention is very well applicable to the manufacture of roof trusses or similar parts that contain a lot of bevels of different directions. It can also be used in the manufacture of logs. It is also very versatile and is not limited to the aforementioned embodiments.

### LIST OF FIGURES

In the following section, the invention will be described in detail by means of examples of its embodiments with reference to the accompanying drawings, wherein:

FIG. 1 schematically shows one sawing apparatus of the invention as seen from the top; and

FIGS. 2a-2d illustrate the principle of one method of the invention.

### DETAILED DESCRIPTION OF THE INVENTION

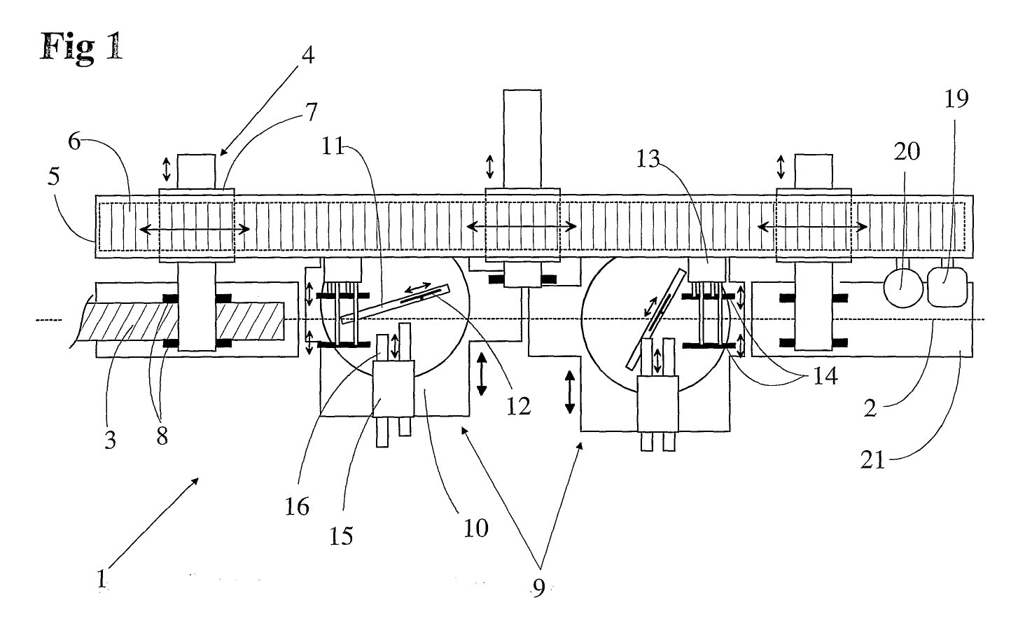

The sawing apparatus 1 of FIG. 1 has a processing line 2 whose centre line is shown in the figure with a dotted line. The ends of the processing line have supporting planes 21 for supporting the timber 3.

Supported on the frame 5 (of which just a part is shown in the figure for the sake of clarity) of the sawing apparatus, in parallel to the processing line, aside from it and above it, is a magnetic rail 6 comprising consecutive permanent magnets. Three linear motor slides 7 have been arranged to be movable along the magnetic rail beneath it. Connected to each slide is a transfer gripper 4. For supporting the slides and for controlling their movement, the sides of the magnetic rail are provided with linear guides (not shown in the figure) connected to the apparatus frame, and the slides move along them. The slides can be moved along the magnetic rail independently with respect to one another. The transfer grippers have been arranged to be movable in the horizontal direction with respect to the processing line. In the figure, this possibility of movement is illustrated by the middlemost transfer gripper that has been put aside from the processing line. The transfer gripper includes two grip portions 8 to be movable e.g. pneumatically in the crosswise direction with respect to the processing line for grasping the timber by clamping it between the grip portions. The grip portions move symmetrically with respect to the centre line of the processing line and center the timber with respect to the processing line irrespective of the width of the timber. In the figure, the transfer gripper of the left-hand side has grasped the timber 3 by its vertical side surfaces for transferring it forward in the processing line.

The apparatus includes two circular saw units 9, which have been arranged to be movable in a crosswise horizontal direction with respect to the processing line, as has been designated with arrows in FIG. 1. The circular saw units include a supporting plane 10 that supports the timber, the supporting plane being provided with a portion that can be turned about its middle axis, as well as with a slit 11 in the portion that is in parallel to the saw blade. The planar, round saw blade 12, which is vertical, has been arranged to be movable in the horizontal direction in a plane defined by the same as well as in the vertical direction. The actual sawing apparatuses that move the entire circular saw units or their blades are disposed underneath the supporting planes and are not shown in the figure. In the figure, the left-hand saw has been moved a little aside from the centre line of the processing line into a place required by the first saw cut of the timber 3 to be transferred to the saw.

According to the invention, the sawing apparatus could also include just one circular saw 9 and just two transfer grippers 4 which are to be moved using linear motors 6, 7.

The apparatus also includes a milling cutter 19 and a drill 20 connected to the frame 5 of the sawing apparatus and arranged to be movable in the vertical direction for machining various indentations and holes in the timber 3 being processed.

Arranged in the vicinity of the circular saws are positioning grippers 13. They include gripping elements 14, arranged to be movable in the crosswise direction of the processing line, symmetrically with respect to its centre line, as has been denoted with arrows in the figure. The gripping elements that move towards each other grasp the timber by its vertical side surfaces. Gripping elements such as these enable one to implement the crosswise positioning of the timber by centering the centre line of the timber so as to match with the centre line of the processing line irrespective of the width of the timber. The movement of the gripping elements may have been arranged to work e.g. pneumatically. In addition, the positioning grippers may have been arranged to be movable so that they can be put aside from the processing line between the positioning phases.

Disposed in conjunction with the circular saws are holding means 15 for holding the timber in place during the machining phase. The holding means are fastened to the supporting plane 10 of the saw and thus move together with the saw during the crosswise movements thereof. The holding means include press portions 16 to be moved in the crosswise direction with respect to the processing line and to be pressed in the vertical direction for pressing the timber against the supporting plane 10 of the saw. The two press portions of the holding element can be moved independently with respect to one another. In this manner, it is possible to move the press portions to the different sides of the sawing line, enabling one to hold the timber in place very firmly during the machining phase. Between the machining phases, the press portions can be put aside from the processing line.

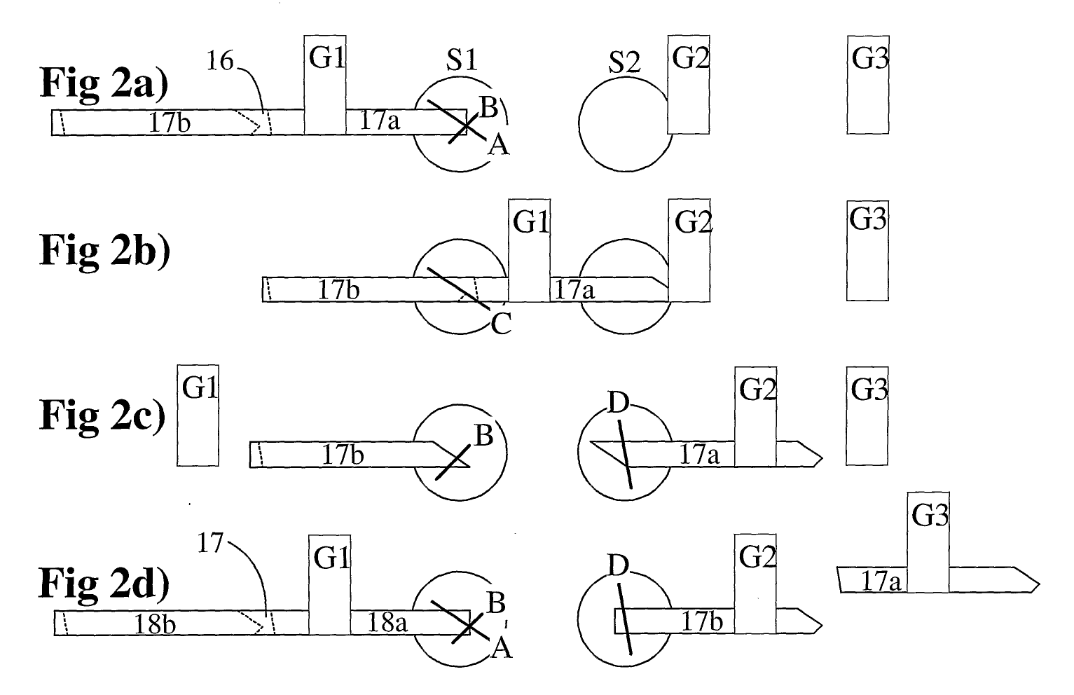

In the method shown in FIGS. 2a-2d, the sawing apparatus is used to make, out of one elongated timber slab 17, 18, two cut-to-size pieces 17a, 18a and 17b, 18b, denoted in the figure with a broken line in the slabs. The figures do not show e.g. the operation of the positioning grippers or the holding elements but concentrate on the principle of the simultaneous use of transfer grippers and two saws. For the sake of simplicity, the crosswise movements of the saws are not shown either.

FIG. 2a illustrates a situation where the transfer gripper G1 has transferred a slab 17 to the first saw S1 for sawing the first end of the first piece 17a. To achieve two bevels, the necessary saw cuts A, B are made at the end of the piece, between which saw cuts the transfer gripper G1 moves the slab the required distance. After the saw cuts have been made, the transfer gripper G1 moves the slab forward.

In FIG. 2b, the transfer gripper G1 has transferred the slab into a place where the first saw S1 can be used to make the first saw cut C of the first end of the second piece 17b, which saw cut at the same time releases the pieces 17a and 17b from one another. After the saw cuts, the transfer gripper G2 transfers the first piece 17a forward. During the sawing (the pieces are held in place during the saw cuts using separate holding elements), the transfer gripper G1 returns backward into the vicinity of the first saw to get ready for the transfer of the second piece 17b into a place required by the second saw cut C of the first end of the piece.

In the situation represented by FIG. 2c, the transfer gripper G2 has transferred the first piece 17a to the second saw S2. The transfer gripper G1 has transferred the second piece 17b into a place required by the second saw cut B to be made at the first end of that piece and has then moved to the starting point of the processing line for picking up the next slab 18. At this step, the second saw is used to make substantially simultaneously a saw cut D at the first end of the first piece 17a, and the first saw is used to make a saw cut B at the first end of the second piece 17b. During the saw cuts, the transfer gripper G2 returns and picks up the second piece from the first saw and the transfer gripper G3 moves so as to grasp the first piece being completed for transferring it forward.

FIG. 2d shows how the transfer gripper G3 has transferred the completed first piece 17a further aside from the processing line. The transfer gripper G2 has transferred the second piece 17b from the first saw S1 to the second saw S2 for making the saw cut D at the second end of the piece, and the transfer gripper G1 has transferred the next timber slab 18 to the saw S1 for machining the saw cuts A and B at the first end of the first piece 18a of the slab. The movements of all the three transfer grippers have been simultaneous, so the processing line is in efficient use at all times, and the method does not involve unnecessary waiting periods. Besides fast release of the exit end of the processing line, the sideward movement of the transfer gripper permits making the processing line shorter.

The crosswise movements of the saws S1 and S2 necessary between the different saw cuts, as well as turning the saws so as to be parallel to each sawing line and moving the saw blade into an optimal position in the processing are performed at the same time with the moves of the timber. In this manner, once the slabs and the pieces have been transferred to the saws by the transfer grippers, the saw cuts can be made immediately without any delays.

The invention is not limited merely to the examples of its embodiments referred to above; instead many variations are possible within the scope of the inventive idea defined by the claims.

1. A sawing apparatus (1) for cutting elongated timber (3) to form cut-to-size pieces, the apparatus including a horizontal processing line (2), through which the timber being processed is guided; transfer means for transferring the timber longitudinally along the processing line; as well as machining means for machining the timber in the processing line, the machining means including at least one circular saw (9) whose sawing angle is adjustable and whose blade can be moved across the processing line for cutting the timber, characterised in that the transfer means include:
an elongated magnetic rail (6) which is parallel to the processing line (2);
at least two linear motor slides (7) that have been arranged to move independently with respect to one another along the magnetic rail; and
for each slide of the linear motor, a transfer gripper (4) attached to the slide, the transfer gripper being arranged to grasp the timber being processed for transferring it longitudinally along the processing line.

2. The sawing apparatus (1) as defined in claim 1, characterised in that there are two pieces of circular saws (9) and they are disposed consecutively in the direction of the processing line.

3. The sawing apparatus (1) as defined in claim 1, characterised in that there are three pieces of combinations of a linear motor slide (7) and a transfer gripper (4) connected to it.

4. The sawing apparatus (1) as defined in claim 1, characterised in that the blade (12) of the circular saw (9) is in a vertical position.

5. The sawing apparatus (1) as defined in claim 1, characterised in that the blade (12) of the circular saw (9) is arranged to be movable in the horizontal direction defined by the plane of the blade.

6. The sawing apparatus (1) as defined in claim 1, characterised in that the circular saw (9) is arranged to be movable in a crosswise horizontal direction with respect to the processing line.

7. The sawing apparatus (1) as defined in claim 1, characterised in that the blade (12) of the circular saw (9) is arranged to be movable in a vertical direction.

8. The sawing apparatus (1) as defined in claim 1, characterised in that the transfer gripper (4) is arranged to be movable in a vertical direction through a stretch longer than the thickness of the timber (3).

9. The sawing apparatus (1) as defined in claim 1, characterised in that the transfer gripper (4) is arranged to be movable in a crosswise horizontal direction with respect to the processing line (2) for moving the transfer gripper aside from the processing line.

10. The sawing apparatus (1) as defined in claim 1, characterised in that the machining means include a milling cutter (19) for machining indentations in the timber.

11. The sawing apparatus (1) as defined in claim 1, characterised in that the machining means include a drill (20) for machining holes in the timber.

12. The sawing apparatus (1) as defined in claim 1, characterised in that arranged in conjunction with the machining means is a positioning gripper (13) for positioning the timber (3) in a crosswise horizontal direction with respect to the processing line prior to the machining phase.

13. The sawing apparatus (1) as defined in claim 1, characterised in that arranged in conjunction with the machining means is a holding member (15) for holding the timber (3) in place during the machining phase.

14. A method for using a sawing apparatus (1) as defined in claim 1 when sawing elongated timber (17, 18) to size, characterised in that a piece of wood (17, 18) being machined is transferred into position for machining using a first transfer gripper (G1) and moving the piece of wood after the machining phase forward in the processing line (2) using a second transfer gripper (G2).

15. The method as defined in claim 14, in that a first saw (S1) is used to saw the first end of an elongated piece of wood (17a, 17b, 18a, 18b) and a second saw (S2) is used to saw the second end of the aforementioned piece of wood.

16. The method as defined in claim 14, characterised in that the piece of wood (3) being machined is first transferred into the vicinity of the machining means (9) using the transfer gripper (4) and is positioned into the desired place in a crosswise direction with respect to the processing line (2), after which the holding member (15) is used to grasp the piece of wood for holding it in place during the machining phase and the transfer gripper is moved so as to be ready for the next transfer.

17. The method as defined in claim 14, characterised in that prior to the sawing, the saw blade is turned so as to be parallel to the desired sawing line (A, B, C, D) and the blade is moved, beneath or above the processing line, into a place where the middle point of the blade is in the vertical direction substantially matching up with the midpoint of the sawing line; and thereafter, the sawing is performed with one vertical movement of the saw blade.
